(19) United States
(12) Patent Application Publication
(10) Pub. No.: US 2019/0074603 A1
(43) Pub. Date: Mar. 7, 2019

(54) METHOD OF MANUFACTURING TERMINAL-EQUIPPED ELECTRIC WIRE

(71) Applicant: Yazaki Corporation, Tokyo (JP)

(72) Inventor: Kenta Furuhata, Shizuoka (JP)

(21) Appl. No.: 16/102,390

(22) Filed: Aug. 13, 2018

(30) Foreign Application Priority Data
Sep. 6, 2017 (JP) 2017-171102

(51) Int. Cl. H01R 4/18; H01R 4/70; H01R 43/00

(52) U.S. Cl. CPC H01R 4/18; H01R 43/00; H01R 4/70

(57) ABSTRACT

A method of manufacturing a terminal-equipped electric wire includes a pre-crimping resin application process of applying a first photocurable resin to a part in which a gap space portion surrounded by a crimp terminal, a conductor portion, and an end of an insulating covering portion is formed in a state in which the crimp terminal is crimped to an electric wire in the crimp terminal before the crimp terminal is crimped to the electric wire, a crimping process, a post-crimping resin application process of applying a second photocurable resin across the conductor portion, a conductor crimping portion, and the insulating covering portion exposed from the crimp terminal after the crimping process, and a resin curing process of irradiating and curing the first photocurable resin and the second photocurable resin with light.

### CROSS-REFERENCE TO RELATED APPLICATION(S)

The present application claims priority to and incorporates by reference the entire contents of Japanese Patent Application No. 2017-171102 filed in Japan on Sep. 6, 2017.

### BACKGROUND OF THE INVENTION

### 1. Field of the Invention

The present invention relates to a method of manufacturing a terminal-equipped electric wire.

### 2. Description of the Related Art

As a conventional method of manufacturing a terminal-equipped electric wire, for example, Japanese Patent Application Laid-open No. 2015-153721 discloses a technology of a method of manufacturing a terminal-equipped electric wire including a process of supplying an anti-corrosive agent in a flowing state to each of a plurality of different portions in the terminal-equipped electric wire.

Incidentally, the method of manufacturing the terminal-equipped electric wire described in Japanese Patent Application Laid-open No. 2015-153721 mentioned above has room for further improvement from a viewpoint of ensuring more reliable water-stopping performance.

### SUMMARY OF THE INVENTION

The present invention has been made in view of the above circumstances, and an object thereof is to provide a method of manufacturing a terminal-equipped electric wire capable of manufacturing a terminal-equipped electric wire ensuring proper water-stopping performance.

In order to achieve the above mentioned object, a method of manufacturing a terminal-equipped electric wire according to one aspect of the present invention includes a pre-crimping resin application process of applying a first photocurable resin cured through exposure to a part of a crimp terminal in which a gap space portion is formed before the crimp terminal is crimped to an electric wire, the crimp terminal including a conductor crimping portion crimped to an electrically conductive conductor portion exposed from an end of an insulating covering portion having an insulation property of the electric wire in which the conductor portion is covered with the insulating covering portion and a cover crimping portion crimped to the insulating covering portion, the gap space portion being surrounded by the crimp terminal, the conductor portion, and the end of the insulating covering portion in a state in which the crimp terminal is crimped to the electric wire; a crimping process of crimping the conductor crimping portion to the conductor portion and crimping the cover crimping portion to the insulating covering portion after the pre-crimping resin application process; a post-crimping resin application process of applying a second photocurable resin cured through exposure across the conductor portion exposed from the crimp terminal, the conductor crimping portion, and the insulating covering portion to cover the conductor portion, the conductor crimping portion, and the insulating covering portion by the second photocurable resin after the crimping process; and a resin curing process of irradiating and curing the first photocurable resin and the second photocurable resin with light.

According to another aspect of the present invention, in the method of manufacturing a terminal-equipped electric wire, it is possible to configure that the first photocurable resin is applied such that the first photocurable resin spreads to a part in which an end portion on an opposite side from the conductor crimping portion side of the cover crimping portion is located in the state in which the crimp terminal is crimped to the electric wire in the pre-crimping resin application process.

According to still another aspect of the present invention, in the method of manufacturing a terminal-equipped electric wire, it is possible to configure that the first photocurable resin and the second photocurable resin are collectively irradiated and cured with light after the post-crimping resin application process in the resin curing process.

According to still another aspect of the present invention, in the method of manufacturing a terminal-equipped electric wire, it is possible to configure that the resin curing process includes a first curing process of irradiating and curing the first photocurable resin with light after the crimping process and before the post-crimping resin application process and a second curing process of irradiating and curing the second photocurable resin with light after the post-crimping resin application process.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a schematic configuration of a terminal-equipped electric wire according to an embodiment;

FIG. 2 is an exploded perspective view illustrating a state of the terminal-equipped electric wire according to the embodiment before crimping a crimp terminal;

FIG. 3 is a flowchart illustrating a method of manufacturing a terminal-equipped electric wire according to the embodiment;

FIG. 4 is a schematic block diagram illustrating a schematic configuration of a terminal-equipped electric wire manufacturing apparatus that performs the method of manufacturing a terminal-equipped electric wire according to the embodiment;

FIG. 5 is a perspective view illustrating an example of a pre-crimping resin application process of the method of manufacturing a terminal-equipped electric wire according to the embodiment;

FIG. 6 is a schematic cross-sectional view illustrating a state after a crimping process of the method of manufacturing a terminal-equipped electric wire according to the embodiment;

FIG. 7 is a perspective view illustrating an example of a post-crimping resin application process of the method of manufacturing a terminal-equipped electric wire according to the embodiment;

FIG. 8 is a perspective view illustrating an example of a resin curing process of the method of manufacturing a terminal-equipped electric wire according to the embodiment;

FIG. 9 is a schematic cross-sectional view illustrating a state after a resin curing process of the method of manufacturing a terminal-equipped electric wire according to the embodiment;

FIG. 10 is a flowchart illustrating a method of manufacturing a terminal-equipped electric wire according to a modification;

FIG. 11 is a schematic block diagram illustrating a schematic configuration of a terminal-equipped electric wire manufacturing apparatus that performs the method of manufacturing a terminal-equipped electric wire according to the modification;

FIG. 12 is a perspective view illustrating an example of a first curing process of the method of manufacturing a terminal-equipped electric wire according to the modification;

FIG. 13 is a perspective view illustrating an example of a pre-crimping resin application process of the method of manufacturing a terminal-equipped electric wire according to a reference example;

FIG. 14 is a schematic side view illustrating an example of an application position of a first photocurable resin in a pre-crimping resin application process of the method of manufacturing a terminal-equipped electric wire according to the reference example;

FIG. 15 is a schematic side view illustrating an example of the application position of the first photocurable resin in the pre-crimping resin application process of the method of manufacturing a terminal-equipped electric wire according to the reference example;

FIG. 16 is a schematic side view illustrating an example of the application position of the first photocurable resin in the pre-crimping resin application process of the method of manufacturing a terminal-equipped electric wire according to the reference example;

FIG. 17 is a schematic side view illustrating an example of the application position of the first photocurable resin in the pre-crimping resin application process of the method of manufacturing a terminal-equipped electric wire according to the reference example; and

FIG. 18 is a perspective view illustrating another example of the pre-crimping resin application process of the method of manufacturing a terminal-equipped electric wire according to the reference example.

### DETAILED DESCRIPTION OF THE PREFERRED EMBODIMENTS

Hereinafter, an embodiment according to the invention will be described in detail below with reference to drawings. It should be noted that the invention is not limited by this embodiment. In addition, a constituent element in the embodiment below includes a constituent element which can be easily replaced by those skilled in the art or substantially the same constituent element.

### Embodiment

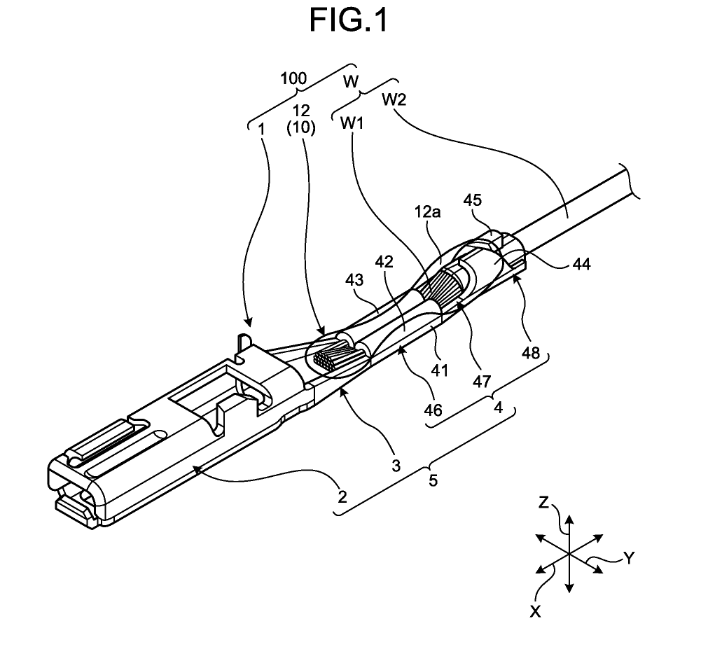

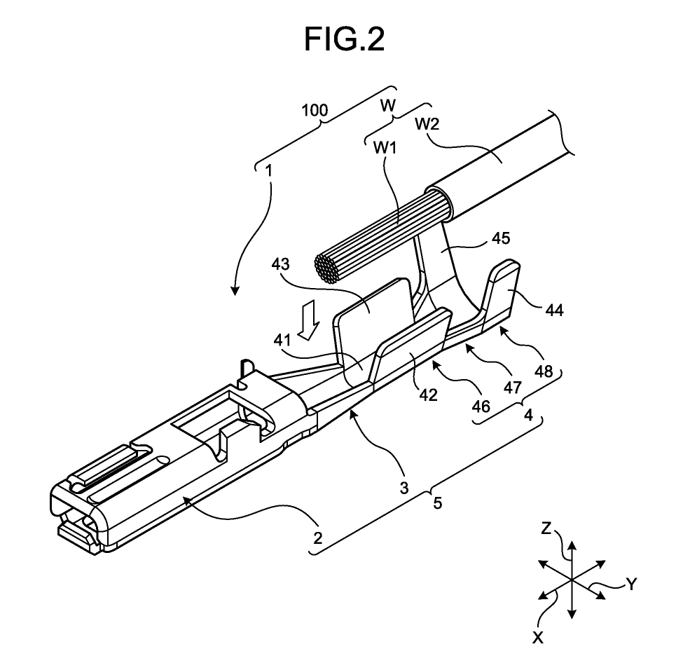

A method of manufacturing a terminal-equipped electric wire according to the present embodiment is a method of manufacturing a terminal-equipped electric wire 100 illustrated in FIGS. 1 and 2. Hereinafter, first, a description will be given of a basic configuration of the terminal-equipped electric wire 100 illustrated in FIGS. 1 and 2, and then a detailed description will be given of the method of manufacturing the terminal-equipped electric wire.

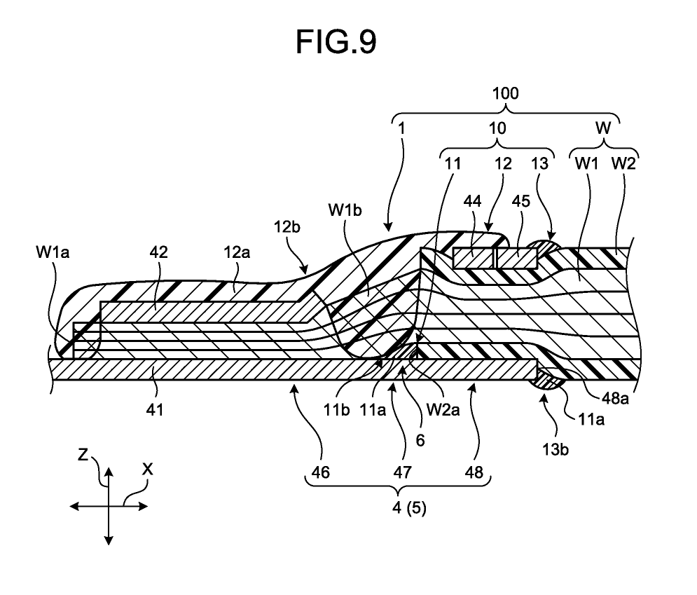

For example, the terminal-equipped electric wire 100 illustrated in FIGS. 1 and 2 is applied to a wire harness, etc. used for a vehicle, etc. Here, for example, the wire harness is obtained by bundling a plurality of electric wires W used for power supply and signal communication for connection between devices mounted on the vehicle to form a collective part, and connecting the plurality of electric wires W to each of the devices at a time using a connector, etc. The terminal-equipped electric wire 100 of the present embodiment includes an electric wire W, a crimp terminal 1 crimped to an end of the electric wire W, and a cured resin water stop portion 10 formed by curing a photocurable resin (a first photocurable resin 11a and a second photocurable resin 12a (see FIG. 9, etc.) described below) to stop water at each portion.

In description below, among a first direction, a second direction, and a third direction intersecting with one another, the first direction is referred to as an “axial direction X”, the second direction is referred to as a “width direction Y”, and the third direction is referred to as a “height direction Z”. Here, the axial direction X, the width direction Y, and the height direction Z are substantially orthogonal to one another. The axial direction X typically corresponds to an extending direction of the electric wire W on which the crimp terminal 1 is provided and corresponds to a direction in which an electric connecting portion 2 and an electric wire crimping portion 4 of the crimp terminal 1 are aligned. The width direction Y and the height direction Z correspond to an intersecting direction intersecting the axial direction X. In addition, each direction used in the following description indicates a direction in a state in which respective portions are assembled to each other, unless otherwise specified.

For example, the electric wire W includes a wire-shaped conductor portion W1 having conductivity and an insulating covering portion W2 covering an outside of the conductor portion W1. The electric wire W is an insulated electric wire in which the conductor portion W1 is covered with the insulating covering portion W2. The conductor portion W1 of the present embodiment is a core wire formed by bundling a plurality of strands of conductive metal such as copper, copper alloy, aluminum, aluminum alloy, etc. However, the conductor portion W1 may be a twisted core wire formed by twisting a plurality of strands. The insulating covering portion W2 is an electric wire coating covering an outer circumferential side of the conductor portion W1. For example, the insulating covering portion W2 is formed by extruding an insulating resin material (PP, PVC, cross-linked PE, etc. appropriately selected in view of wear resistance, chemical resistance, heat resistance, etc.), etc. In the electric wire W, the insulating covering portion W2 is peeled off at least at one end of the conductor portion W1, the one end of the conductor portion W1 is exposed from an end W2a (see FIG. 6, etc.) of the insulating covering portion W2, and the crimp terminal 1 is crimped to the exposed end of the conductor portion W1. Here, the electric wire W is formed to extend with substantially the same diameter with respect to the extending direction that linearly extends, a cross-sectional shape of the conductor portion W1 (a cross-sectional shape in a direction intersecting the extending direction) is a substantially circular shape, a cross-sectional shape of the insulating covering portion W2 is a substantially annular shape, and the electric wire W has a substantially circular cross-sectional shape as a whole.

The crimp terminal 1 includes the electric connecting portion 2, a joining portion 3, and the electric wire crimping portion 4. The electric connecting portion 2, the joining portion 3, and the electric wire crimping portion 4 are integrally made of an electrically conductive metal, for example, copper, a copper alloy, aluminum, an aluminum alloy, etc. as a whole, and constitute a terminal metal fitting 5. In the crimp terminal 1, for example, respective portions such as the electric connecting portion 2, the joining portion 3, the electric wire crimping portion 4, etc. are three-dimensionally and integrally formed by pressing and bending one metal plate punched out into shapes corresponding to the respective portions. In the crimp terminal 1, from one side to the other side along the axial direction X, the electric connecting portion 2, the joining portion 3, and the electric wire crimping portion 4 are arranged in this order and connected to one another.

The electric connecting portion 2 is a portion electrically connected to an electrically conductive member. For example, the electrically conductive member of the present embodiment is a counterpart terminal (not illustrated). That is, here, the electric connecting portion 2 of the present embodiment is configured as a terminal connection portion electrically connected to the counterpart terminal. The electric connecting portion 2 may have a male terminal shape or a female terminal shape. The electric connecting portion 2 of the present embodiment is illustrated as the female terminal shape and electrically connected to the counterpart terminal having the male terminal shape. The electrically conductive member may not correspond to the counterpart terminal, and may correspond to, for example, various electrically conductive members such as a grounding member, etc. The electric connecting portion 2 may not be included in the terminal connection portion electrically connected to the counterpart terminal, and may have, for example, a shape of a so-called round terminal (LA terminal) fastened to the grounding member, etc.

The joining portion 3 is a portion interposed between the electric connecting portion 2 and the electric wire crimping portion 4 to connect the electric connecting portion 2 and the electric wire crimping portion 4 to each other. In the crimp terminal 1, the electric connecting portion 2 and the electric wire crimping portion 4 are electrically connected through the joining portion 3, and the electric connecting portion 2 and the conductor portion W1 of the electric wire W are electrically connected through the electric wire crimping portion 4 to conduct electricity.

The electric wire crimping portion 4 is a portion that electrically connects the crimp terminal 1 to the end of the electric wire W. The electric wire crimping portion 4 is caulked and crimped to the end of the electric wire W. The electric wire crimping portion 4 includes a base portion 41 and two sets of pairs of barrel pieces 42, 43, 44, and 45. The electric wire crimping portion 4 is caulked and crimped to the electric wire W by the base portion 41 and the two sets of pairs of barrel pieces 42, 43, 44, and 45. In the electric wire crimping portion 4, a conductor crimping portion 46, an intermediate portion 47, and a cover crimping portion 48 are configured by the base portion 41 and the two sets of pairs of barrel pieces 42, 43, 44, and 45. In other words, the electric wire crimping portion 4 includes the conductor crimping portion 46, the intermediate portion 47, and the cover crimping portion 48 configured by the base portion 41 and the two sets of pairs of barrel pieces 42, 43, 44, and 45. The conductor crimping portion 46 is configured by a part of the base portion 41 and a pair of barrel pieces 42 and 43. The intermediate portion 47 is configured by a part of the base portion 41. The cover crimping portion 48 is configured by a part of the base portion 41 and a pair of barrel pieces 44 and 45. In the electric wire crimping portion 4, from the electric connecting portion 2 side to the opposite side along the axial direction X, the conductor crimping portion 46, the intermediate portion 47, and the cover crimping portion 48 are arranged in this order and connected to one another. Further, the electric wire crimping portion 4 constitutes a so-called separate barrel type crimping portion in which the pair of barrel pieces 42 and 43 and the pair of barrel pieces 44 and 45 are separated through the intermediate portion 47.

The base portion 41 is a portion that extends along the axial direction X and corresponds to a bottom wall of the electric wire crimping portion 4 formed in a U-shape. An end portion of the electric wire W is placed on the base portion 41 during a crimping process. The electric connecting portion 2 is connected to the base portion 41 on one side in the axial direction X through the joining portion 3. A carrier is connected to the base portion 41 on the other side in the axial direction X in a state before the crimping process. For example, the base portion 41 is cut from the carrier during the crimping process.

The pair of barrel pieces 42 and 43 is a portion included in the conductor crimping portion 46 together with a part of the base portion 41. The conductor crimping portion 46 is a portion provided on one end side in the axial direction X, here, on the electric connecting portion 2 side in the electric wire crimping portion 4 and caulked and crimped to the conductor portion W1 of the electric wire W. In addition, the conductor crimping portion 46 is a portion electrically connected to the conductor portion W1 by being caulked and crimped to the conductor portion W1. Each of the pair of barrel pieces 42 and 43 is a portion formed to extend in a band shape on each of both sides in the width direction Y from the base portion 41 in the conductor crimping portion 46 and caulked and crimped with the conductor portion W1 of the electric wire W wrapped between the barrel pieces 42 and 43 and the base portion 41. The barrel pieces 42 and 43 are portions corresponding to side walls of the electric wire crimping portion 4 formed in a U-shape in a state before the crimping process. The barrel piece 42 extends to one side in the width direction Y intersecting the axial direction X from the base portion 41. The barrel piece 43 extends to the other side in the width direction Y from the base portion 41. In a state before being caulked and crimped to the conductor portion W1 of the electric wire W (see FIG. 2), a bending process is performed on the base portion 41, and the barrel pieces 42 and 43 are formed in a substantially U-shape together with the base portion 41. The pair of barrel pieces 42 and 43 of the present embodiment is wound around the electric wire W and caulked, and a length thereof from a root on the base portion 41 side to a distal end is set such that the barrel pieces 42 and 43 do not overlap with each other in a crimped state. Lengths of the pair of barrel pieces 42 and 43 from the root on the base portion 41 side to the distal end may be equal to each other, and one length may be longer than the other length. Here, the pair of barrel pieces 42 and 43 is illustrated as caulked and crimped portions referred to as a so-called B crimp. However, the embodiment is not limited thereto. In the B crimp, each of the barrel pieces 42 and 43 is bent toward the base portion 41 side and caulked and crimped such that the distal end portion is pressed toward the electric wire W. The conductor crimping portion 46 wraps the outside of the conductor portion W1 of the electric wire W located between the pair of barrel pieces 42 and 43 by the base portion 41 and the pair of barrel pieces 42 and 43, and is caulked and crimped to the conductor portion W1. In the conductor crimping portion 46, a serration, etc. for increasing a contact area with the conductor portion W1, improving contact stability, and improving agglutination strength may be provided in a part in contact with the conductor portion W1 in the base portion 41 and the pair of barrel pieces 42 and 43. In addition, the conductor crimping portion 46 may be configured such that the pair of barrel pieces 42 and 43 is overlapped with each other in a state of being wound around the electric wire W, caulked, and crimped.

The pair of barrel pieces 44 and 45 is a portion included in the cover crimping portion 48 together with a part of the base portion 41. The cover crimping portion 48 is a portion provided on the other end side in the axial direction X, here on the opposite side from the electric connecting portion 2 side in the electric wire crimping portion 4 and caulked and crimped to the insulating covering portion W2 of the electric wire W. Here, in the electric wire crimping portion 4, the intermediate portion 47 is interposed between the cover crimping portion 48 and the conductor crimping portion 46 with respect to the axial direction X. The intermediate portion 47 is a portion interposed between the conductor crimping portion 46 and the cover crimping portion 48 to connect the conductor crimping portion 46 and the cover crimping portion 48 to each other. Each of the pair of barrel pieces 44 and 45 is a portion formed to extend in a band shape on each of both sides in the width direction Y from the base portion 41 in the cover crimping portion 48 and caulked and crimped with the insulating covering portion W2 of the electric wire W wrapped between the barrel pieces 44 and 45 and the base portion 41. The barrel pieces 44 and 45 are portions corresponding to side walls of the electric wire crimping portion 4 formed in a U-shape in the state before the crimping process. The barrel piece 44 extends to one side in the width direction Y intersecting the axial direction X from the base portion 41. The barrel piece 45 extends to the other side in the width direction Y from the base portion 41. In a state before being caulked and crimped to the insulating covering portion W2 of the electric wire W (see FIG. 2), a bending process is performed on the base portion 41, and the barrel pieces 44 and 45 are formed in a substantially U-shape together with the base portion 41. The barrel pieces 44 and 45 are formed to be separated from the barrel pieces 42 and 43 at intervals by the intermediate portion 47 being interposed between the barrel pieces 44 and 45 and the barrel pieces 42 and 43, respectively. The pair of barrel pieces 44 and 45 of the present embodiment is wound around the electric wire W and caulked, and a length thereof from a root on the base portion 41 side to a distal end is set such that the barrel pieces 44 and 45 do not overlap with each other in a crimped state. Further, the barrel pieces 44 and 45 are formed to be shifted in the axial direction X. Lengths of the pair of barrel pieces 44 and 45 from the root on the base portion 41 side to the distal end may be equal to each other, and one length may be longer than the other length. The cover crimping portion 48 wraps the outside of the insulating covering portion W2 of the electric wire W located between the pair of barrel pieces 44 and 45 by the base portion 41 and the pair of barrel pieces 44 and 45, and is caulked and crimped to the insulating covering portion W2. The cover crimping portion 48 may be configured such that the pair of barrel pieces 44 and 45 is overlapped with each other in a state of being wound around the electric wire W, caulked, and crimped.

The cured resin water stop portion 10 is formed by curing a photocurable resin (the first photocurable resin 11a and the second photocurable resin 12a (see FIG. 9, etc.)) to stop water in each portion of the terminal-equipped electric wire 100. Here, as illustrated in FIG. 9 described below, the cured resin water stop portion 10 includes a first cured resin water stop portion 11 and a second cured resin water stop portion 12. The first cured resin water stop portion 11 is a portion that stops water in a predetermined part inside the crimp terminal 1 by the first photocurable resin 11a corresponding to a photocurable resin being applied to the predetermined part inside the crimp terminal 1 and cured. The second cured resin water stop portion 12 is a portion that stops water in a predetermined part outside the crimp terminal 1 by the second photocurable resin 12a corresponding to a photocurable resin being applied to the predetermined part outside the crimp terminal 1 and cured. In addition, the cured resin water stop portion 10 of the present embodiment further includes a third cured resin water stop portion 13. Similarly to the first cured resin water stop portion 11, the third cured resin water stop portion 13 is a portion formed by applying and curing the first photocurable resin 11a. However, here, the third cured resin water stop portion 13 is a portion provided at an end portion 48a (see FIG. 9, etc.) on the opposite side from the conductor crimping portion 46 side of the cover crimping portion 48 to stop water. Both the first photocurable resin 11a and the second photocurable resin 12a are resins cured when cure extent is changed through exposure. For example, it is possible to use an ultraviolet (UV) curable type resin cured by being irradiated with an ultraviolet ray. For example, a urethane acrylate resin may be used as the UV curable type resin. However, the embodiment is not limited thereto. Typically, the same UV curable type resin may be used for the first photocurable resin 11a and the second photocurable resin 12a. However, for example, different resins may be used depending on the situation at the time of application of each of the resins, etc. For example, viscosity, etc. may be different therebetween. Typically, the first photocurable resin 11a is applied to a predetermined part in a pre-crimping resin application process (Step ST2) described below. Meanwhile, typically, the second photocurable resin 12a is applied to a predetermined part in a post-crimping resin application process (Step ST5) described below.

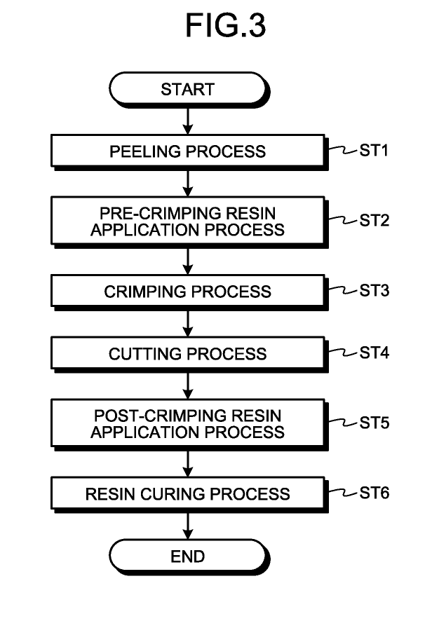

Next, a description will be given of a method of manufacturing the terminal-equipped electric wire 100 (method of manufacturing a terminal-equipped electric wire) configured as described above with reference to FIGS. 3 to 9. In description below, while a description is given based on a flowchart of FIG. 3, other figures are appropriately referred to. The method of manufacturing the terminal-equipped electric wire 100 described below may be manually performed by an operator using various apparatuses, equipment, jigs, etc., or may be automatically performed by various manufacturing apparatuses.

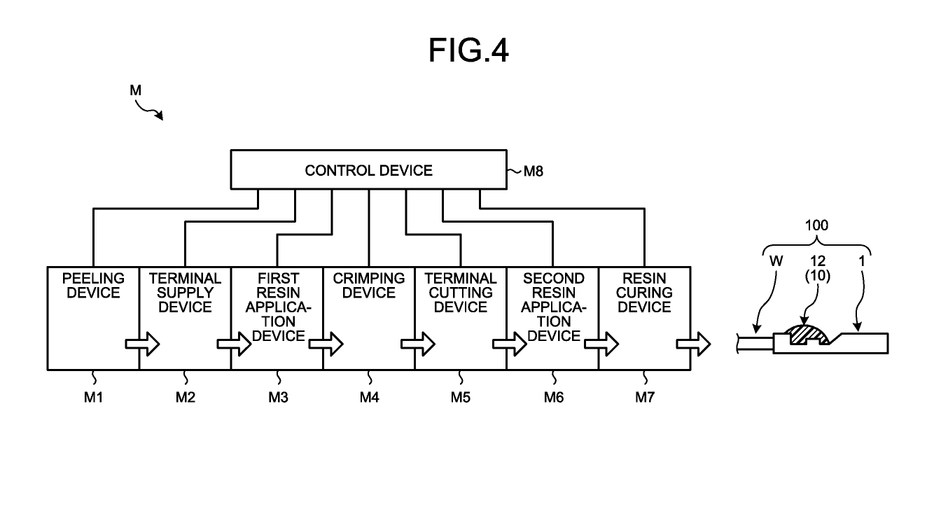

A description will be given on the assumption that the method of manufacturing the terminal-equipped electric wire 100 of the present embodiment is automatically performed by a manufacturing apparatus M as a terminal-equipped electric wire manufacturing apparatus illustrated in FIG. 4. The manufacturing apparatus M includes a peeling device M1, a terminal supply device M2, a first resin application device M3, a crimping device M4, a terminal cutting device M5, a second resin application device M6, a resin curing device M7, and a control device M8. For example, the terminal supply device M2, the crimping device M4, and the terminal cutting device M5 may be referred to as an applicator in this technical field by being integrated.

The peeling device M1 corresponds to various known automatic strip devices that peel off the insulating covering portion W2 at one end of the electric wire W and expose one end of the conductor portion W1 from the end W2a of the insulating covering portion W2 (see FIG. 6, etc.). This peeling device M1 performs a peeling process (Step ST1).

The terminal supply device M2 corresponds to various known supply devices that draw the crimp terminal 1 at a head on an outer circumferential side of a terminal chain body wound in a reel shape and successively supply the drawn crimp terminal 1 to downstream devices (here, the first resin application device M3, etc.). Here, the terminal chain body is obtained by connecting a plurality of crimp terminals 1 before the crimping process, in which a shape of each portion is formed by a press process or a bending process, through a carrier, etc. and is provided in the terminal supply device M2 in a state of being wound in the reel shape.

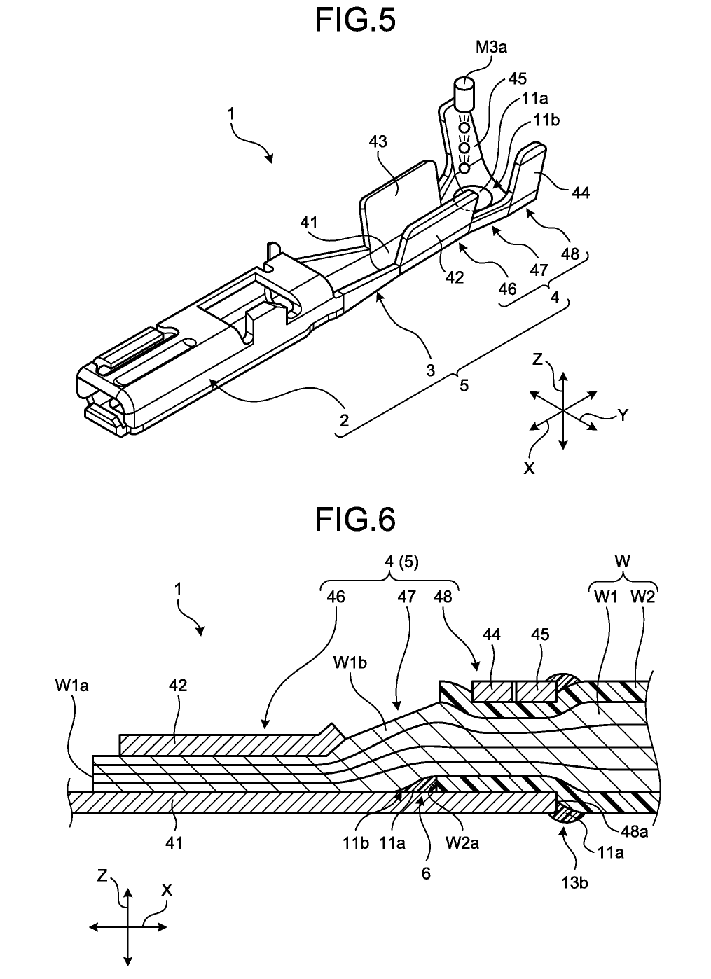

The first resin application device M3 corresponds to various known devices that intermittently transfer a fixed amount of the first photocurable resin 11a toward a nozzle M3a (see FIG. 5, etc.) such as a dispenser by reciprocation of a piston, etc. Then, the first resin application device M3 intermittently ejects and applies droplets of the first photocurable resin 11a transferred to the nozzle M3a from the nozzle M3a. The first resin application device M3 may relatively move the nozzle M3a with respect to an application target part 11b (see FIG. 5, etc.) described below along the axial direction X and the width direction Y. According to this configuration, it is possible to apply the first photocurable resin 11a to the application target part 11b at an arbitrary position. The first resin application device M3 performs the pre-crimping resin application process (Step ST2).

The crimping device M4 corresponds to various known devices that crimp the conductor crimping portion 46 to the conductor portion W1 and crimp the cover crimping portion 48 to the insulating covering portion W2 using a so-called anvil as a lower mold and a crimper as an upper mold. The crimping device M4 performs a crimping process (Step ST3).

The terminal cutting device M5 corresponds to various known devices that separate the crimp terminal 1 after crimping from the terminal chain body. The terminal cutting device M5 performs a cutting process (Step ST4). The terminal cutting device M5 may separate the crimp terminal 1 from the terminal chain body (cutting process) simultaneously with progress of crimping (crimping process) of the crimp terminal 1 by the crimping device M4.

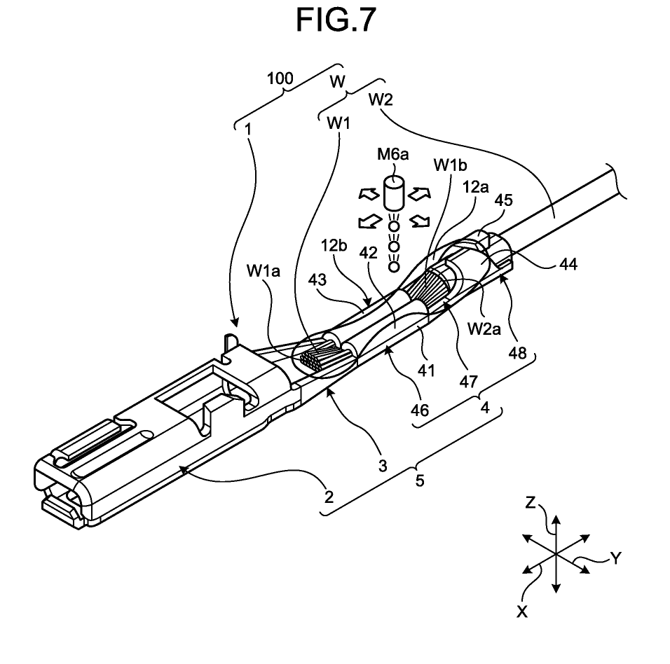

Similarly to the first resin application device M3, the second resin application device M6 corresponds to various known devices that intermittently transfer a fixed amount of the second photocurable resin 12a toward a nozzle M6a (see FIG. 7, etc.) such as a dispenser by reciprocation of a piston, etc. Then, the second resin application device M6 intermittently ejects and applies droplets of the second photocurable resin 12a transferred to the nozzle M6a from the nozzle M6a. The second resin application device M6 may relatively move the nozzle M6a with respect to an application target part 12b (see FIG. 7, etc.) described below along the axial direction X and the width direction Y. According to this configuration, it is possible to apply the second photocurable resin 12a to the application target part 12b at an arbitrary position. The second resin application device M6 performs a post-crimping resin application process (Step ST5). One of the first resin application device M3 and the second resin application device M6 may be used as the other one.

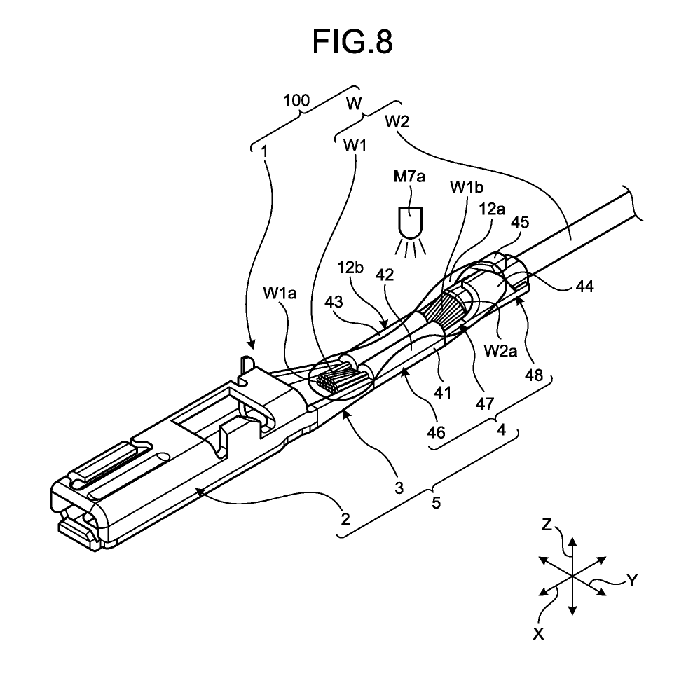

The resin curing device M7 corresponds to various known devices that irradiate the first photocurable resin 11a and the second photocurable resin 12a with light from a light source M7a (see FIG. 8, etc.) to cure the resins. A UV-light emitting diode (LED) may be used as the light source M7a. The UV-LED used as the light source M7a is a light-emitting element capable of emitting an ultraviolet ray for curing the first photocurable resin 11a and the second photocurable resin 12a corresponding to UV curable type resins. The resin curing device M7 performs a resin curing process (Step ST6).

The control device M8 corresponds to a part that executes various arithmetic processes and comprehensively controls each unit of the manufacturing apparatus M. The control device M8 includes an electronic circuit mainly including a well-known microcomputer having a central arithmetic processing apparatus such as a central processing unit (CPU), a read only memory (ROM), a random access memory (RAM), and an interface. The control device M8 controls the peeling device M1, the terminal supply device M2, the first resin application device M3, the crimping device M4, the terminal cutting device M5, the second resin application device M6, and the resin curing device M7, and executes the respective processes such as the peeling process (Step ST1), the pre-crimping resin application process (Step ST2), the crimping process (Step ST3), the cutting process (Step ST4), the post-crimping resin application process (Step ST5), the resin curing process (Step ST6), etc. Here, after applying the first photocurable resin 11a using the first resin application device M3, the control device M8 crimps the crimp terminal 1 to the electric wire W using the crimping device M4, applies the second photocurable resin 12a using the second resin application device M6, and performs a process of collectively curing the first photocurable resin 11a and the second photocurable resin 12a using the resin curing device M7. Hereinafter, the respective processes will be described in detail.

First, the control device M8 executes peeling processing of controlling the peeling device M1 to peel off the insulating covering portion W2 at one end of the electric wire W, thereby exposing one end of the conductor portion W1 from the end W2a of the insulating covering portion W2 (see FIG. 6, etc.) as the peeling process (Step ST1). Then, the control device M8 executes subsequent processes while controlling the terminal supply device M2 to perform a process of drawing the crimp terminal 1 at the head on the outer circumferential side of the terminal chain body and successively supplying the crimp terminal 1 to subsequent devices (here, the first resin application device M3, etc.).

Subsequently, after the peeling process (Step ST1), as illustrated in FIG. 5, as the pre-crimping resin application process, the control device M8 controls the first resin application device M3 to perform pre-crimping resin application processing to apply the first photocurable resin 11a to a predetermined part before crimping the crimp terminal 1 to the electric wire W (Step ST2). In the pre-crimping resin application process (pre-crimping resin application processing), the control device M8 of the present embodiment intermittently ejects droplets of the first photocurable resin 11a from the nozzle Mia, and applies the first photocurable resin 11a to a part of the crimp terminal tin which a gap space portion 6 illustrated in FIG. 6 is formed.

Here, as illustrated in FIG. 6, the gap space portion 6 is a space portion surrounded by the crimp terminal 1, the conductor portion W1, and the end W2a of the insulating covering portion W2 in a state in which the crimp terminal 1 is crimped to the electric wire W. In the state in which the crimp terminal 1 is crimped to the electric wire W, the end W2a of the insulating covering portion W2 is located between the conductor crimping portion 46 and the cover crimping portion 48, that is, in the intermediate portion 47. The gap space portion 6 is a gap formed between an inner surface of the base portion 41 of the crimp terminal 1 and an outer surface of the conductor portion W1 due to a step corresponding to a thickness of the end W2a of the insulating covering portion W2 on the inside of the crimp terminal 1. The gap space portion 6 is formed as a substantially arc-shaped gap along the step generated according to the thickness of the end W2a of the insulating covering portion W2.

In the pre-crimping resin application process (Step ST2), the first resin application device M3 applies the first photocurable resin 11a before crimping of the crimp terminal 1 to the part of the crimp terminal 1 in which the gap space portion 6 is formed after crimping of the crimp terminal 1. That is, the first resin application device M3 sets the part in which the gap space portion 6 is formed after crimping as the application target part (first application target part) 11b in the crimp terminal 1 before crimping of the crimp terminal 1, and applies the first photocurable resin 11a to the application target part 11b. In other words, the application target part 11b is a part in which the above-described first cured resin water stop portion 11 (see FIG. 9) is provided. Here, for example, as illustrated in FIG. 5, the application target part 11b is a part located in a connection portion of the intermediate portion 47 and the cover crimping portion 48 and on the inner surface of the base portion 41 in the crimp terminal 1. For example, the first resin application device M3 positions the nozzle M3a such that the nozzle M3a faces the application target part 11b on the inner surface of the base portion 41 of the crimp terminal 1 in the height direction Z, ejects droplets of the first photocurable resin 11a, and applies the droplets to the application target part 11b from the nozzle M3a.

In addition, in the pre-crimping resin application process (Step ST2), as illustrated in FIG. 6, the control device M8 may control the first resin application device M3 to apply the first photocurable resin 11a as described below. That is, the control device M8 may apply the first photocurable resin 11a such that the first photocurable resin 11a spreads to a part in which the end portion 48a of the cover crimping portion 48 is located in the state in which the crimp terminal 1 is crimped to the electric wire W. Here, the end portion 48a of the cover crimping portion 48 is an end portion on the opposite side from the conductor crimping portion 46 side of the cover crimping portion 48. That is, the first resin application device M3 sets a part in which the end portion 48a is located after crimping as an application target part (third application target part) 13b in the electric wire W before crimping of the crimp terminal 1, and applies the first photocurable resin 11a such that the first photocurable resin 11a spreads to the application target part 13b after crimping. In other words, the application target part 13b is a part in which the above-described third cured resin water stop portion 13 (see FIG. 9) is provided. For example, the first resin application device M3 applies the first photocurable resin 11a to the application target part 11b illustrated in FIG. 5 at a sufficient amount to spread the first photocurable resin 11a to the application target part 13b after crimping of the crimp terminal 1. In this way, the first resin application device M3 may allow the first photocurable resin 11a to spread to the application target part 13b after crimping. In addition, the first resin application device M3 may allow the first photocurable resin 11a to spread to the application target part 13b after crimping by directly applying the first photocurable resin 11a to the application target part 13b.

Subsequently, after the pre-crimping resin application process (Step ST2), the control device M8 performs crimping processing of controlling the crimping device M4 to crimp the conductor crimping portion 46 of the crimp terminal 1 to the conductor portion W1 and crimp the cover crimping portion 48 to the insulating covering portion W2 as the crimping process (Step ST3). In the crimping process (Step ST3), the crimping device M4 caulks and crimps the crimp terminal 1 to the electric wire W while deforming the electric wire crimping portion 4 of the crimp terminal 1 using the anvil and the crimper. More specifically, the crimping device M4 places the peeled electric wire W among the two sets of pairs of barrel pieces 42, 43, 44, and 45 in a state in which the base portion 41 of the electric wire crimping portion 4 is placed on a placement surface of the anvil. The crimping device M4 places the electric wire W on the base portion 41 such that the conductor portion W1 is located between the barrel pieces 42 and 43 of the conductor crimping portion 46, the insulating covering portion W2 is located between the barrel pieces 44 and 45 of the cover crimping portion 48, and the end W2a is located between the conductor crimping portion 46 and the cover crimping portion 48. Then, while the crimper disposed at a position facing the anvil in the height direction Z relatively moves closer to the anvil side along the height direction Z, the crimping device M4 presses each of the two sets of pairs of barrel pieces 42, 43, 44, and 45 to the base portion 41 side, gradually tilts the barrel piece inward, and deforms the barrel piece. In this way, the crimping device M4 wraps and caulks the conductor portion W1 between the base portion 41 and the pair of barrel pieces 42 and 43 in the conductor crimping portion 46, and crimps the pair of barrel pieces 42 and 43 to the conductor portion W1. Similarly, the crimping device M4 wraps and caulks the insulating covering portion W2 between the base portion 41 and the pair of barrel pieces 44 and 45 in the cover crimping portion 48, and crimps the pair of barrel pieces 44 and 45 to the insulating covering portion W2. In the crimp terminal 1, as illustrated in FIG. 6, in a state in which the conductor crimping portion 46 is crimped to the conductor portion W1, and the cover crimping portion 48 is crimped to the insulating covering portion W2, the conductor crimping portion 46 and the conductor portion W1 directly come into contact with each other, adhere to each other, and conduct electricity. Then, in the crimp terminal 1, in the pre-crimping resin application process (Step ST2) prior to the crimping process (Step ST3), the first photocurable resin 11a is applied to the application target part 11b of the crimp terminal 1. For this reason, the crimp terminal 1 is in a state in which the first photocurable resin 11a is filled in the gap space portion 6 while the crimp terminal 1 is crimped to the electric wire W. In addition, here, the crimp terminal 1 is in a state in which the first photocurable resin 11a applied to the application target part 11b of the crimp terminal 1 spreads to the application target part 13b on the end portion 48a side of the cover crimping portion 48 after crimping in the pre-crimping resin application process (Step ST2) prior to the crimping process (Step ST3).

Subsequently, after the crimping process (Step ST3) or in parallel with the crimping process (Step ST3), the control device M8 performs cutting processing of controlling the terminal cutting device M5 to separate the crimp terminal 1 crimped to the electric wire W from the terminal chain body as the cutting process (Step ST4).

Subsequently, after the cutting process (Step ST4), as illustrated in FIG. 7, as the post-crimping resin application process, the control device M8 performs post-crimping resin application processing of controlling the second resin application device M6 to apply the second photocurable resin 12a to a predetermined part after crimping the crimp terminal 1 to the electric wire W (Step ST5). In the post-crimping resin application process (post-crimping resin application processing), the control device M8 of the present embodiment intermittently ejects droplets of the second photocurable resin 12a from the nozzle M6a, and applies the second photocurable resin 12a to the application target part (second application target part) 12b illustrated in FIG. 7. In other words, the application target part 12b is a part in which the above-described second cured resin water stop portion 12 (see FIG. 9) is provided. As illustrated in FIG. 7, the application target part 12b is a part that covers the conductor portion W1 exposed from the crimp terminal 1, the conductor crimping portion 46, and the insulating covering portion W2 across the conductor portion W1, the conductor crimping portion 46, and the insulating covering portion W2. Further, for example, the application target part 12b may include a gap between strands inside the conductor portion W1 in the electric wire W. In other words, in the post-crimping resin application process (Step ST5), the second photocurable resin 12a may be applied to penetrate the gap between the strands inside the conductor portion W1. For example, as illustrated in FIG. 7, the second resin application device M6 positions the nozzle M6a on the opposite side from a side at which the base portion 41 is located in the height direction Z, and ejects and applies droplets of the second photocurable resin 12a to the application target part 12b from the nozzle M6a. The second photocurable resin 12a applied to the application target part 12b forms a film in the application target part 12b, that is, integrally covers the conductor portion W1 exposed from the crimp terminal 1, the conductor crimping portion 46, and the insulating covering portion W2 across the conductor portion W1, the conductor crimping portion 46, and the insulating covering portion W2. More specifically, the second photocurable resin 12a integrally covers a distal end W1a of the conductor portion W1, a part of the conductor crimping portion 46, an intermediate exposed portion W1b of the conductor portion W1, the end W2a of the insulating covering portion W2, a part of the intermediate portion 47, and a part of the cover crimping portion 48. The distal end W1a of the conductor portion W1 is a portion exposed toward the electric connecting portion 2 side from the conductor crimping portion 46. The intermediate exposed portion W1b is a portion exposed between the conductor crimping portion 46 and the end W2a of the insulating covering portion W2. In addition, it is preferable that the second photocurable resin 12a is applied to be filled at least in a groove formed by distal end portions of the barrel pieces 42 and 43 facing each other. Further, the second photocurable resin 12a penetrates the gap between the strands inside the conductor portion W1.

Subsequently, after the post-crimping resin application process (Step ST5), as illustrated in FIG. 8, the control device M8 performs resin curing processing of controlling the resin curing device M7 to irradiate and cure the first photocurable resin 11a and the second photocurable resin 12a with light as the resin curing process (Step ST6), and ends the method of manufacturing the terminal-equipped electric wire 100. In the resin curing process (Step ST6), the resin curing device M7 of the present embodiment collectively irradiates and cures the first photocurable resin 11a and the second photocurable resin 12a with light after the post-crimping resin application process (Step ST5). For example, as illustrated in FIG. 8, the resin curing device M7 positions the light source M7a on the opposite side from the side at which the base portion 41 is located in the height direction Z, and irradiates the first photocurable resin 11a and the second photocurable resin 12a with an ultraviolet ray from the light source M7a. The ultraviolet ray emitted from the light source M7a diffusely reflects on the surface of the strand of the conductor portion W1 and reaches and cures the first photocurable resin 11a filled in the gap space portion 6 and the second photocurable resin 12a penetrating into the inside of the conductor portion W1. The first photocurable resin 11a and the second photocurable resin 12a are cured by being irradiated with the ultraviolet ray from the light source M7a and retain shapes thereof.

As illustrated in FIG. 9, the first photocurable resin 11a is applied to the application target part 11b before crimping of the crimp terminal 1 and irradiated with an ultraviolet ray while being filled in the gap space portion 6 after crimping. As a result, the first photocurable resin 11a is cured inside the gap space portion 6 on the inside of the crimp terminal 1 to form the first cured resin water stop portion 11. In this way, the first cured resin water stop portion 11 may reliably stop water inside the gap space portion 6 on the inside of the crimp terminal 1 in the terminal-equipped electric wire 100. In addition, the first photocurable resin 11a is cured on the end portion 48a side of the cover crimping portion 48 by being irradiated with an ultraviolet ray while spreading to the application target part 13b after crimping of the crimp terminal 1, thereby forming the third cured resin water stop portion 13. In this way, the third cured resin water stop portion 13 may reliably stop water on the end portion 48a side of the cover crimping portion 48 in the terminal-equipped electric wire 100. Meanwhile, the second photocurable resin 12a is cured on the outside of the crimp terminal 1 by being irradiated with an ultraviolet ray while integrally covering the conductor portion W1 exposed from the crimp terminal 1, the conductor crimping portion 46, and the insulating covering portion W2 across the conductor portion W1, the conductor crimping portion 46, and the insulating covering portion W2, thereby forming the second cured resin water stop portion 12. In this way, the second cured resin water stop portion 12 may integrally and reliably stop water by covering the distal end W1a of the conductor portion W1, a part of the conductor crimping portion 46, the intermediate exposed portion W1b of the conductor portion W1, the end W2a of the insulating covering portion W2, a part of the intermediate portion 47, and a part of the cover crimping portion 48 in the terminal-equipped electric wire 100. In other words, the second cured resin water stop portion 12 may block an exposed portion of the conductor portion W1 from an external space and reliably stop water.

In the method of manufacturing the terminal-equipped electric wire 100 and the manufacturing apparatus M described above, the first photocurable resin 11a is applied to the application target part 11b of the crimp terminal 1 in which the gap space portion 6 is formed before the crimp terminal 1 is crimped to the electric wire W. The gap space portion 6 is a space portion surrounded by the crimp terminal 1, the conductor portion W1, and the end W2a of the insulating covering portion W2. Thereafter, in this manufacturing method and manufacturing apparatus M, the conductor crimping portion 46 and the cover crimping portion 48 are crimped to the conductor portion W1 and the insulating covering portion W2. Then, in this manufacturing method and manufacturing apparatus M, the second photocurable resin 12a is applied across the conductor portion W1 exposed from the crimp terminal 1, the conductor crimping portion 46, the insulating covering portion W2, etc., and these portions are covered by the second photocurable resin 12a. Then, in this manufacturing method and manufacturing apparatus M, the first photocurable resin 11a and the second photocurable resin 12a are irradiated with light and cured. As a result, in this manufacturing method and manufacturing apparatus M, it is possible to reliably stop water in the gap space portion 6 surrounded by the crimp terminal 1, the conductor portion W1, and the end W2a of the insulating covering portion W2 using the cured first photocurable resin 11a, that is, the first cured resin water stop portion 11. In other words, in this manufacturing method and manufacturing apparatus M, the first cured resin water stop portion 11 is reliably formed in the gap space portion 6 formed after crimping of the crimp terminal 1 by the first photocurable resin 11a applied to the crimp terminal 1 before the crimp terminal 1 is crimped to the electric wire W, and water may be stopped. Further, in this manufacturing method and manufacturing apparatus M, the first cured resin water stop portion 11 is reliably formed in the gap space portion 6 on the inside of the crimp terminal 1 to which the first photocurable resin 11a is difficult to apply after crimping of the crimp terminal 1, and water may be stopped. In addition, in this manufacturing method and manufacturing apparatus M, for example, it is possible to ensure that the first cured resin water stop portion 11 is reliably present in the gap space portion 6 inside the crimp terminal 1 as described above without performing various destructive inspections or nondestructive inspections. As a result, in this manufacturing method and manufacturing apparatus M, it is possible to ensure the water-stopping performance of the gap space portion 6 by the first cured resin water stop portion 11. In addition, in this manufacturing method and manufacturing apparatus M, the first photocurable resin 11a is applied to the application target part 11b in a pinpoint manner rather than applying the first photocurable resin 11a on the entire portion in contact with the conductor portion W1 exposed from the end W2a of the insulating covering portion W2 in the crimp terminal 1. As a result, the crimp terminal 1 may directly bring the conductor crimping portion 46 and the conductor portion W1 into contact with each other to conduct electricity without interposing the first photocurable resin 11a therebetween in a portion in which the conductor crimping portion 46 and the conductor portion W1 come into contact with each other to conduct electricity while the crimp terminal 1 is crimped to the electric wire W. In this way, the crimp terminal 1 can ensure proper conduction performance. That is, in this manufacturing method and manufacturing apparatus M, it is possible to ensure both proper water-stopping and corrosion protection performance and proper conduction performance in the terminal-equipped electric wire 100. In addition, in this manufacturing method and manufacturing apparatus M, further, it is possible to stop water in the exposed portion of the conductor portion W1 by the cured second photocurable resin 12a, that is, the second cured resin water stop portion 12. In this way, in this manufacturing method and manufacturing apparatus M, it is possible to reliably stop water around the conductor portion W1 and restrict entry of moisture, etc. toward the conductor portion W1 side between the conductor portion W1 and the crimp terminal 1, thereby manufacturing the terminal-equipped electric wire 100 ensuring proper water-stopping performance. As a result, the terminal-equipped electric wire 100 manufactured by the manufacturing method and the manufacturing apparatus M may ensure proper water-stopping performance and ensure proper corrosion protection performance. For example, in the terminal-equipped electric wire 100, in a case in which a material of the conductor portion W1 is aluminum and a material of the crimp terminal 1 is copper, when water intrudes therebetween, there is concern that the conductor portion W1 may corrode (galvanic corrosion) due to a difference in ionization tendency. On the other hand, the terminal-equipped electric wire 100 may suppress occurrence of corrosion by restricting entry of water as described above.

In addition, in this manufacturing method and manufacturing apparatus M, the first photocurable resin 11a is applied to the application target part 11b on the crimp terminal 1 side in a part in which the gap space portion 6 is formed after crimping of the crimp terminal 1. In this way, in this manufacturing method and manufacturing apparatus M, the first photocurable resin 11a may be easily applied to the application target part 11b on the crimp terminal 1 side from an upper side in a vertical direction (height direction Z), and thus the first photocurable resin 11a may easily remain in the application target part 11b. In this regard, in this manufacturing method and manufacturing apparatus M, it is possible to manufacture the terminal-equipped electric wire 100 that reliably stops water around the conductor portion W1 and ensures proper water-stopping performance. In addition, in this manufacturing method and manufacturing apparatus M, for example, when compared to a case in which the first photocurable resin 11a is applied to the electric wire W, it is possible to easily adjust application timing of the first photocurable resin 11a with respect to the application target part 11b on the crimp terminal 1 side, and thus productivity may be improved.

Further, in the manufacturing method and the manufacturing apparatus M described above, in the pre-crimping resin application process (Step ST2), the first photocurable resin 11a is applied such that the first photocurable resin 11a spreads to the application target part 13b in which the end portion 48a of the cover crimping portion 48 is located in the state in which the crimp terminal 1 is crimped to the electric wire W. Therefore, in this manufacturing method and manufacturing apparatus M, it is possible to reliably stop water in a part in which the end portion 48a is located on the opposite side from the conductor crimping portion 46 side of the cover crimping portion 48 by the first photocurable resin 11a applied to the application target part 13b and cured, that is, the third cured resin water stop portion 13. As a result, in this manufacturing method and manufacturing apparatus M, it is possible to manufacture the terminal-equipped electric wire 100 ensuring more proper water-stopping performance.

Further, in the manufacturing method and the manufacturing apparatus M described above, in the resin curing process (Step ST6), the first photocurable resin 11a and the second photocurable resin 12a are collectively irradiated with an ultraviolet ray and cured. As a result, in this manufacturing method and manufacturing apparatus M, it is possible to shorten a manufacturing process and to efficiently manufacture the terminal-equipped electric wire 100.

Modification

In the resin curing process (Step ST6) described above, a description has been given on the assumption that the first photocurable resin 11a and the second photocurable resin 12a are collectively irradiated with light and cured. However, the invention is not limited thereto.

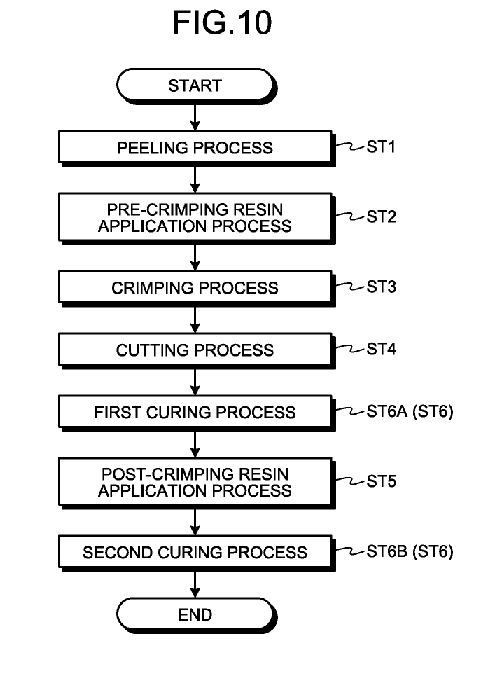

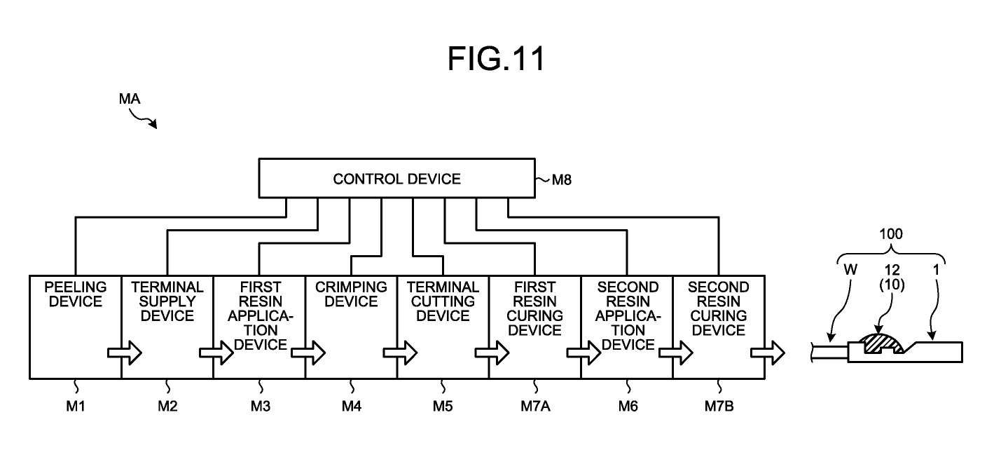

FIGS. 10, 11, and 12 are diagrams illustrating a method of manufacturing a terminal-equipped electric wire 100 (method of manufacturing a terminal-equipped electric wire) according to a modification and a manufacturing apparatus MA as a terminal-equipped electric wire manufacturing apparatus according to a modification. The method of manufacturing the terminal-equipped electric wire 100 according to the present modification is different from the above-described embodiment in that the resin curing process (Step ST6) includes a first curing process (Step ST6A) and a second curing process (Step ST6B), and the other processes are substantially the same as those of the above-described embodiment. Accordingly, the manufacturing apparatus MA according to the present modification is different in that the resin curing device M7 includes a first resin curing device M7A and a second resin curing device M7B, and the other devices are substantially the same as those of the above-described embodiment. The first resin curing device M7A and the second resin curing device M7B have substantially the same configuration as that of the resin curing device M7 described above, and are configured to be able to emit light, here, an ultraviolet ray for curing the first photocurable resin 11a and the second photocurable resin 12a from the light source M7a. In the manufacturing apparatus MA, the first resin curing device M7A is provided between the terminal cutting device M5 and the second resin application device M6, and the second resin curing device M7B is provided subsequent to the second resin application device M6. After applying the first photocurable resin 11a using the first resin application device M3, the control device M8 according to the present modification performs a process of crimping the crimp terminal 1 to the electric wire W using the crimping device M4, curing the first photocurable resin 11a using the first resin curing device M7A serving as the resin curing device M7, applying the second photocurable resin 12a using the second resin application device M6, and curing the second photocurable resin 12a using the second resin curing device M7B serving as the resin curing device M7. Hereinafter, the respective processes of the present modification will be described in detail. However, constituent elements similar to those in the above-described embodiment are denoted by common reference symbols, and redundant descriptions of common structures, actions, and effects are omitted as much as possible.

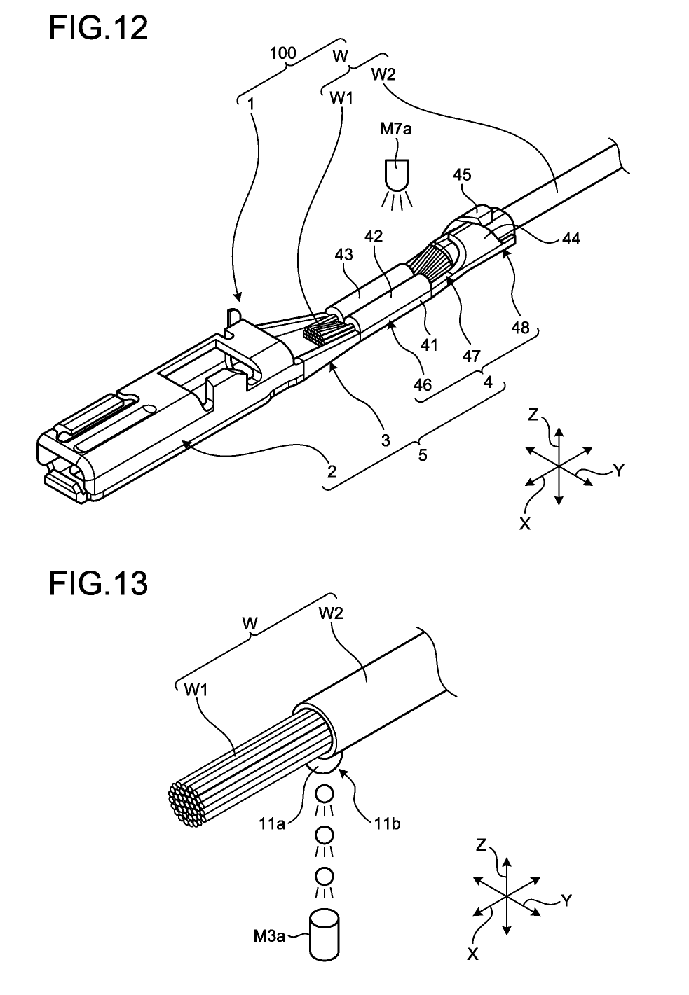

In the method of manufacturing the terminal-equipped electric wire 100 according to the present modification, after the cutting process (Step ST4), the first curing process (Step ST6A) of the resin curing process (Step ST6) is performed. After the crimping process (Step ST3) and before the post-crimping resin application process (Step ST5), here, after the cutting process (Step ST4) and before the post-crimping resin application process (Step ST5), the control device M8 performs the first resin curing process (Step ST6A) as a first curing process of the resin curing process (Step ST6). That is, as illustrated in FIG. 12, as the first curing process (Step ST6A) of the resin curing process (Step ST6), the control device M8 performs first resin curing processing of controlling the first resin curing device M7A to irradiate and cure the first photocurable resin 11a with an ultraviolet ray (light). In addition, in the method of manufacturing the terminal-equipped electric wire 100 according to the present modification, the second curing process (Step ST6B) of the resin curing process (Step ST6) is performed after the post-crimping resin application process (Step ST5). The control device M8 performs second resin curing processing (Step ST6B) as the second curing process of the resin curing process (Step ST6) after the post-crimping resin application process (Step ST5), and ends the method of manufacturing the terminal-equipped electric wire 100. That is, the control device M8 performs second resin curing processing of controlling the second resin curing device M7B to irradiate and cure the second photocurable resin 12a with an ultraviolet ray (light) as the second curing process (Step ST6B) of the resin curing process (Step ST6), and ends the method of manufacturing the terminal-equipped electric wire 100. In this case, in this manufacturing method and manufacturing apparatus MA, similarly to the above description, it is possible to manufacture the terminal-equipped electric wire 100 that reliably stops water around the conductor portion W1 and ensures proper water-stopping performance.

In addition, in the above description, typically, the same UV curable type resin may be used as the first photocurable resin 11a and the second photocurable resin 12a. However, for example, different resins may be used depending on the situation, etc. at the time of application. For example, the resins may have different viscosities. For example, a resin having a relatively high viscosity may be used as the first photocurable resin 11a, and a resin having a relatively low viscosity may be used as the second photocurable resin 12a. When the first photocurable resin 11a has the relatively high viscosity, the first photocurable resin 11a may easily remain in the application target part 11b after being applied to the application target part 11b. Meanwhile, when the second photocurable resin 12a has the relatively low viscosity, the second photocurable resin 12a easily spreads in the application target part 12b after being applied to the application target part 12b, and may easily penetrates into the gap, etc. between the strands inside the conductor portion W1. In addition, conversely, a resin having a relatively low viscosity may be used as the first photocurable resin 11a, and a resin having a relatively high viscosity may be used as the second photocurable resin 12a.

In addition, in the above description, a description has been given on the assumption that the control device M8 applies the first photocurable resin 11a such that the first photocurable resin 11a spreads to the application target part 13b after crimping of the crimp terminal 1 in the pre-crimping resin application process (Step ST2). However, the invention is not limited thereto.

In addition, in the post-crimping resin application process (Step ST5) described above, it is possible to use other devices such as a pressurizing device, a decompressing device, a vibrating device, etc. for promoting penetration of the second photocurable resin 12a into the conductor portion W1.

### Reference Example

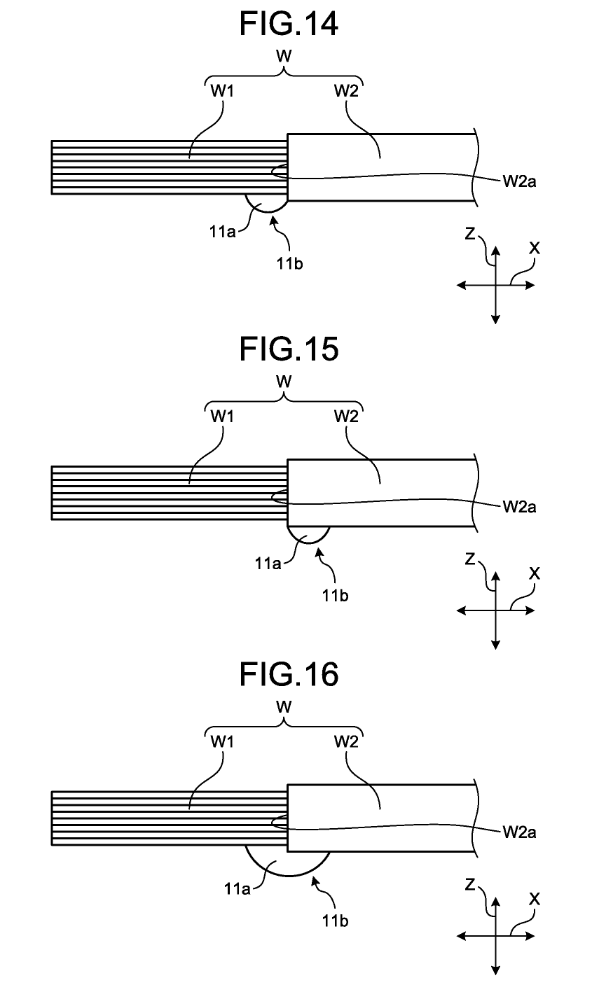

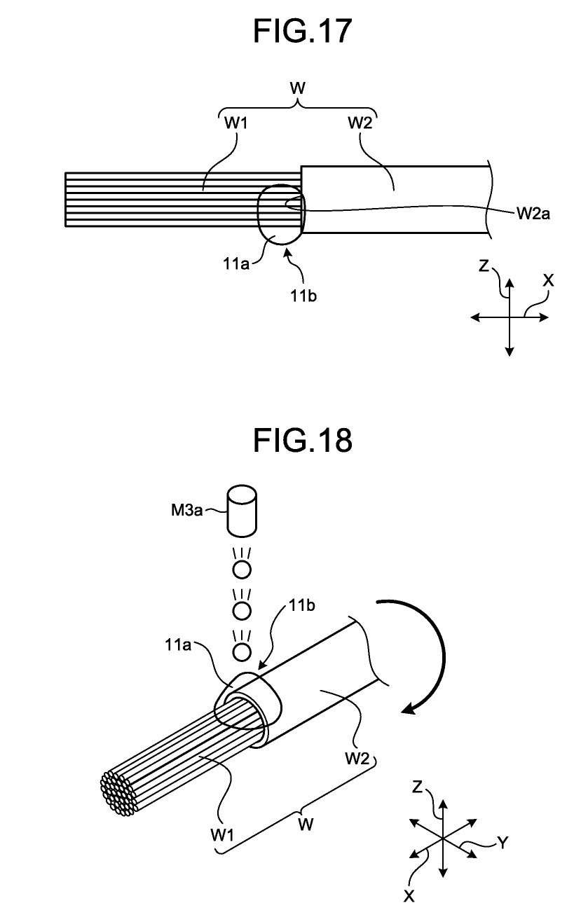

FIGS. 13 to 18 are diagrams for description of a method of manufacturing a terminal-equipped electric wire 100 (method of manufacturing a terminal-equipped electric wire) according to a reference example. The method of manufacturing the terminal-equipped electric wire 100 according to the reference example is different from the above-described embodiment in that the first photocurable resin 11a is applied on the electric wire W side as illustrated in FIG. 13 in the pre-crimping resin application process (Step ST2), and the other processes are substantially the same as those in the above-described embodiment. In the pre-crimping resin application process (pre-crimping resin application processing), a control device M8 of the present reference example intermittently ejects droplets of the first photocurable resin 11a from the nozzle Mia, and applies the first photocurable resin 11a to a part of in the electric wire W in which the gap space portion 6 (see FIG. 6) is formed. That is, a first resin application device M3 of the present reference example sets a part in which the gap space portion 6 is formed after crimping as an application target part (first application target part) 11b in the electric wire W before the crimp terminal 1 is crimped, and applies the first photocurable resin 11a to the application target part 11b. Here, for example, as illustrated in FIG. 14, the application target part 11b corresponds to a part adjacent to the end W2a with respect to the axial direction X in the conductor portion W1 of the electric wire W and located on the base portion 41 side after crimping of the crimp terminal 1 with respect to the height direction Z. Alternatively, for example, as illustrated in FIG. 15, the application target part 11b may correspond to a part adjacent to the end W2a with respect to the axial direction X in the insulating covering portion W2 of the electric wire W and located on the base portion 41 side after crimping of the crimp terminal 1 with respect to the height direction Z. Alternatively, for example, as illustrated in FIG. 16, the application target part 11b may correspond to a part that extends across the conductor portion W1 and the insulating covering portion W2 with the end W2a interposed therebetween with respect to the axial direction X in the electric wire W and is located on the base portion 41 side after crimping of the crimp terminal 1 with respect to the height direction Z. Further, for example, as illustrated in FIG. 17, in addition to the part illustrated in FIG. 16, the application target part 11b may include the gap between the strands inside the conductor portion W1 in the electric wire W. In other words, in the pre-crimping resin application process (Step ST2), the first photocurable resin 11a may be applied to penetrate into the gap between the strands inside the conductor portion W1. For example, as illustrated in FIG. 13, the first resin application device M3 positions the nozzle M3a on the side at which base portion 41 is located after crimping of the crimp terminal 1 in the height direction Z, and ejects and applies droplets of the first photocurable resin 11a to the application target part 11b from the nozzle M3a. Alternatively, for example, as illustrated in FIG. 18, the first resin application device M3 may position the nozzle M3a on the opposite side from the side at which the base portion 41 is located after crimping of the crimp terminal 1 in the height direction Z, and apply droplets of the first photocurable resin 11a. In this case, after ejecting and applying the droplets of the first photocurable resin 11a to the application target part 11b from the nozzle M3a, the first resin application device M3 may rotate the electric wire W by 180° around the axial direction X.

In the manufacturing method and the manufacturing apparatus M according to the reference example, similarly to the above description, it is possible to manufacture the terminal-equipped electric wire 100 that reliably stops water around the conductor portion W1 and ensures proper water-stopping performance. In addition, in the manufacturing method and the manufacturing apparatus M according to the reference example, the first photocurable resin 11a is applied to the application target part 11b on the electric wire W side in the part in which the gap space portion 6 is formed after crimping of the crimp terminal 1. In this way, in this manufacturing method and manufacturing apparatus M, it is possible to directly and accurately apply the first photocurable resin 11a to the application target part 11b in the vicinity of the conductor portion W1 of the electric wire W in which water is stopped. In this regard, in this manufacturing method and manufacturing apparatus M, it is possible to manufacture the terminal-equipped electric wire 100 that reliably stops water around the conductor portion W1 and ensures proper water-stopping performance.

Considering the above-described embodiment and the above-described reference example, a method of manufacturing a terminal-equipped electric wire may be regarded as “a method of manufacturing a terminal-equipped electric wire including a pre-crimping resin application process of applying a first photocurable resin cured through exposure to a part of an electric wire and/or a crimp terminal in which a gap space portion is formed before the crimp terminal is crimped to the electric wire, the crimp terminal including a conductor crimping portion crimped to an electrically conductive conductor portion exposed from an end of an insulating covering portion having an insulation property of the electric wire in which the conductor portion is covered with the insulating covering portion and a cover crimping portion crimped to the insulating covering portion, the gap space portion being surrounded by the crimp terminal, the conductor portion, and the end of the insulating covering portion in a state in which the crimp terminal is crimped to the electric wire, a crimping process of crimping the conductor crimping portion to the conductor portion and crimping the cover crimping portion to the insulating covering portion after the pre-crimping resin application process, a post-crimping resin application process of applying a second photocurable resin cured through exposure across the conductor portion exposed from the crimp terminal, the conductor crimping portion, and the insulating covering portion e to cover the conductor portion, the conductor crimping portion, and the insulating covering portion by the second photocurable resin after the crimping process, and a resin curing process of irradiating and curing the first photocurable resin and the second photocurable resin with light”. Similarly, a terminal-equipped electric wire manufacturing apparatus may be regarded as “a terminal-equipped electric wire manufacturing apparatus including a first resin application device that applies a first photocurable resin cured through exposure to a part of an electric wire and/or a crimp terminal in which a gap space portion is formed before the crimp terminal is crimped to the electric wire, the crimp terminal including a conductor crimping portion crimped to an electrically conductive conductor portion exposed from an end of an insulating covering portion having an insulation property of the electric wire in which the conductor portion is covered with the insulating covering portion and a cover crimping portion crimped to the insulating covering portion, the gap space portion being surrounded by the crimp terminal, the conductor portion, and the end of the insulating covering portion in a state in which the crimp terminal is crimped to the electric wire, a crimping device that crimps the conductor crimping portion to the conductor portion and crimps the cover crimping portion to the insulating covering portion, a second resin application device that applies a second photocurable resin cured through exposure across the conductor portion exposed from the crimp terminal, the conductor crimping portion, and the insulating covering portion to cover the conductor portion, the conductor crimping portion, and the insulating covering portion by the second photocurable resin in the state in which the crimp terminal is crimped to the electric wire, a resin curing device that irradiates and cures the first photocurable resin and the second photocurable resin with light, and a control device capable of controlling the first resin application device, the crimping device, the second resin application device, and the resin curing device to perform a process of applying the first photocurable resin using the first resin application device, and then crimping the crimp terminal to the electric wire using the crimping device, applying the second photocurable resin using the second resin application device, and collectively curing the first photocurable resin and the second photocurable resin using the resin curing device or a process of applying the first photocurable resin using the first resin application device, and then crimping the crimp terminal to the electric wire using the crimping device, curing the first photocurable resin using the resin curing device, applying the second photocurable resin using the second resin application device, and curing the second photocurable resin using the resin curing device”. Further, the above-described reference example “applies the first photocurable resin to the part of the electric wire in which the gap space portion surrounded by the crimp terminal, the conductor portion, and the end of the insulating covering portion is formed in the state in which the crimp terminal is crimped to the electric wire in the pre-crimping resin application process”. Meanwhile, the above-described embodiment “applies the first photocurable resin to the part of the crimp terminal in which the gap space portion surrounded by the crimp terminal, the conductor portion, and the end of the insulating covering portion is formed in the state in which the crimp terminal is crimped to the electric wire in the pre-crimping resin application process”.

The method of manufacturing a terminal-equipped electric wires according to the embodiment and the modification of the invention described above are not limited to the embodiment and the modification described above, and may be variously modified within the scope described in claims. The methods of manufacturing a terminal-equipped electric wire according to the present embodiment and the modification may be configured by appropriately combining constituent elements of the respective embodiment and modification described above.

A method of manufacturing a terminal-equipped electric wire according to the embodiment applies a first photocurable resin to a part in which a gap space portion surrounded by a crimp terminal, a conductor portion, and an end of an insulating covering portion is formed before the crimp terminal is crimped to an electric wire. Thereafter, in the method of manufacturing a terminal-equipped electric wire, a conductor crimping portion and a cover crimping portion are crimped to the conductor portion and the insulating covering portion, a second photocurable resin is applied across the conductor portion exposed from the crimp terminal, the conductor crimping portion, and the insulating covering portion, and the conductor portion, the conductor crimping portion, and the insulating covering portion are covered by the second photocurable resin. Then, in the method of manufacturing a terminal-equipped electric wire, the first photocurable resin and the second photocurable resin are irradiated and cured with light. As a result, in the method of manufacturing a terminal-equipped electric wire, after reliably stopping water in the gap space portion surrounded by the crimp terminal, the conductor portion, and the end of the insulating covering portion using the cured first photocurable resin, water may be stopped in an exposed portion of the conductor portion using the cured second photocurable resin. In this way, the method of manufacturing a terminal-equipped electric wire has an effect that it is possible to manufacture a terminal-equipped electric wire ensuring proper water-stopping performance.

A terminal-equipped electric wire manufacturing apparatus according to the embodiment includes a first resin application device that applies a first photocurable resin cured through exposure to a part of a crimp terminal in which a gap space portion is formed before the crimp terminal is crimped to an electric wire, the crimp terminal including a conductor crimping portion crimped to an electrically conductive conductor portion exposed from an end of an insulating covering portion having an insulation property of the electric wire in which the conductor portion is covered with the insulating covering portion and a cover crimping portion crimped to the insulating covering portion, the gap space portion being surrounded by the crimp terminal, the conductor portion, and the end of the insulating covering portion in a state in which the crimp terminal is crimped to the electric wire, a crimping device that crimps the conductor crimping portion to the conductor portion and crimps the cover crimping portion to the insulating covering portion, a second resin application device that applies a second photocurable resin cured through exposure across the conductor portion exposed from the crimp terminal, the conductor crimping portion, and the insulating covering portion to cover the conductor portion, the conductor crimping portion, and the insulating covering portion by the second photocurable resin in the state in which the crimp terminal is crimped to the electric wire, a resin curing device that irradiates and cures the first photocurable resin and the second photocurable resin with light, and a control device capable of controlling the first resin application device, the crimping device, the second resin application device, and the resin curing device to perform a process of applying the first photocurable resin using the first resin application device, and then crimping the crimp terminal to the electric wire using the crimping device, applying the second photocurable resin using the second resin application device, and collectively curing the first photocurable resin and the second photocurable resin using the resin curing device or a process of applying the first photocurable resin using the first resin application device, and then crimping the crimp terminal to the electric wire using the crimping device, curing the first photocurable resin using the resin curing device, applying the second photocurable resin using the second resin application device, and curing the second photocurable resin using the resin curing device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of manufacturing a terminal-equipped electric wire, the method comprising:
a pre-crimping resin application process of applying a first photocurable resin cured through exposure to a part of a crimp terminal in which a gap space portion is formed before the crimp terminal is crimped to an electric wire, the crimp terminal including a conductor crimping portion crimped to an electrically conductive conductor portion exposed from an end of an insulating covering portion having an insulation property of the electric wire in which the conductor portion is covered with the insulating covering portion and a cover crimping portion crimped to the insulating covering portion, the gap space portion being surrounded by the crimp terminal, the conductor portion, and the end of the insulating covering portion in a state in which the crimp terminal is crimped to the electric wire;
a crimping process of crimping the conductor crimping portion to the conductor portion and crimping the cover crimping portion to the insulating covering portion after the pre-crimping resin application process;
a post-crimping resin application process of applying a second photocurable resin cured through exposure across the conductor portion exposed from the crimp terminal, the conductor crimping portion, and the insulating covering portion to cover the conductor portion, the conductor crimping portion, and the insulating covering portion by the second photocurable resin after the crimping process; and
a resin curing process of irradiating and curing the first photocurable resin and the second photocurable resin with light.

2. The method of manufacturing a terminal-equipped electric wire according to claim 1, wherein
the first photocurable resin is applied such that the first photocurable resin spreads to a part in which an end portion on an opposite side from the conductor crimping portion side of the cover crimping portion is located in the state in which the crimp terminal is crimped to the electric wire in the pre-crimping resin application process.

3. The method of manufacturing a terminal-equipped electric wire according to claim 1, wherein
the first photocurable resin and the second photocurable resin are collectively irradiated and cured with light after the post-crimping resin application process in the resin curing process.

4. The method of manufacturing a terminal-equipped electric wire according to claim 2, wherein
the first photocurable resin and the second photocurable resin are collectively irradiated and cured with light after the post-crimping resin application process in the resin curing process.

5. The method of manufacturing a terminal-equipped electric wire according to claim 1, wherein
the resin curing process includes a first curing process of irradiating and curing the first photocurable resin with light after the crimping process and before the post-crimping resin application process and a second curing process of irradiating and curing the second photocurable resin with light after the post-crimping resin application process.

6. The method of manufacturing a terminal-equipped electric wire according to claim 2, wherein
the resin curing process includes a first curing process of irradiating and curing the first photocurable resin with light after the crimping process and before the post-crimping resin application process and a second curing process of irradiating and curing the second photocurable resin with light after the post-crimping resin application process.
